(19) United States
(12) Patent Application Publication
(10) Pub. No.: US 2012/0150870 A1
(43) Pub. Date: Jun. 14, 2012

(54) IMAGE DISPLAY DEVICE CONTROLLED RESPONSIVE TO SHARING BREADTH

(76) Inventors: Ting-Yee Liao, Webster, NY (US); Lawrence B. Landry, Victor, NY (US)

(21) Appl. No.: 12/964,797

(22) Filed: Dec. 10, 2010

(51) Int. Cl. G06F 17/30

(52) U.S. Cl. 707/748; 707/E17.044

(57) ABSTRACT

A digital image display device for displaying a collection of digital media assets, comprising: a display screen; a processor; a network connection for communicating with a network; an image memory; and a processor-accessible program memory. The processor-accessible memory stores executable instructions for causing the processor to execute the steps of: receiving a plurality of digital media assets using one or more different origins; determining an importance value for each of the received digital media assets responsive to an associated sharing breadth; and performing an operation using at least one of the received digital media assets responsive to the determined importance value.

### CROSS-REFERENCE TO RELATED APPLICATIONS

Reference is made to commonly assigned, co-pending U.S. patent application Ser. No. 12/911,959 (docket 96336) to Krolczyk et al, entitled “Digital media frame providing customized content;” commonly assigned, co-pending U.S. patent application Ser. No. 12/946,055 (docket 96337) to Landry et al., entitled “Image display device providing improved media selection;” commonly assigned, co-pending U.S. patent application Ser. No. 12/948,892 (Docket 96338) to Landry, entitled “Method for remotely configuring a digital image display device;” commonly-assigned U.S. patent application Ser. No. 12/949,029 (Docket 96689) to Landry, entitled “Digital image display device with automatically adjusted image display durations;” U.S. patent application Ser. No. 12/949,054 (Docket 96690) to Telek et al., entitled “Digital image display device with remotely disableable user interface;” and U.S. patent application Ser. No. 12/949,086 (Docket 96713) to Telek et al., entitled “Digital image display device with remote viewing interface,” each of which is incorporated herein by reference.

### FIELD OF THE INVENTION

This invention pertains to the field of digital media frames, and more particularly to digital media frames that act on digital media assets responsive to a determined importance value based in part on the breadth of how the digital media asset was shared.

### BACKGROUND OF THE INVENTION

A digital media frame (also called a digital photo frame, a digital picture frame or a digital image display device) is a device that electronically stores and displays digital media assets. As used herein, the term digital media assets includes both digital still images and digital video images. The digital media assets are typically captured using digital cameras (still or video), but may also be obtained using other types of digital media asset sources such as digital scanners. For example, U.S. Pat. No. 4,754,271 to Edwards, entitled “Liquid crystal photograph,” describes a device resembling a pocket calculator which stores still pictures in a digital memory cartridge, and displays the pictures on a liquid crystal display (LCD) screen. The device includes an auto-sequencing mode which automatically changes the displayed image after a user-selectable time period, such as 5 seconds, or 5 minutes.

Digital media frames can include a modem to receive digital media assets over a communications network from computers or other devices, as described in commonly-assigned U.S. Pat. No. 7,155,679 to Bandaru, et al., entitled “Digital media frame,” which is incorporated herein by reference. Such a digital media frame is commonly known as a “connected frame”. This patent further teaches that the connected digital media frame can include an information mode which displays news headlines, stock trading news, weather reports, and advertising received over the communications network.

Some digital media frames can receive digital media assets over a network from a “share group” which includes a plurality of members, as described in commonly-assigned U.S. Pat. No. 6,509,910 to Agarwal, et al., entitled “Method and system for interfacing with a digital media frame network,” which is incorporated herein by reference. This patent teaches that images provided by various sharing members can be downloaded from a network service and automatically displayed on digital media frames which communicate with the network service.

FrameChannel is an Internet service that can be used with a digital media frame having a modem which enables an Internet connection, such as a WiFi modem, that enables communication with an Internet Service Provider (ISP) via a wireless home router. A FrameChannel customer can use a home computer to access the FrameChannel website (www.framechannel.com) in order to customize the content that will be provided to their digital media frame. The customer can select from many different channels of custom content including news, traffic, weather, sports, and financial data. The customer can also use FrameChannel to receive photos from social networking or digital media asset sharing websites such as Facebook and Flickr, and to receive photos via E-mail and camera phone messages.

In current connected digital media frames, it is common to include a mode which displays a slide show of pictures. Normally, the images are displayed using the same display interval for all of the pictures, and the slide show either contains all images, all recently shared images, or a subset of user selected images. As the available memory in digital media frames increases, it is possible to store and view several thousand different digital media assets. The large number of digital media assets can overwhelm the viewer.

Even when a large memory is used, the digital media frame will eventually become full, and some images will need to be deleted so that more images can be stored. The deletion is typically done manually by the user, using a tedious process of selecting images to be removed. In some prior art digital image storage systems, images are deleted automatically if the customer does not place an order using these images in a specified period of time, as described in commonly-assigned U.S. Pat. No. 6,631,011 to Fredlund et al, entitled “System and method for selecting photographic images using index prints,” which incorporated herein by reference.

Some prior art Digital Video Recorders (DVRs) employ viewer preferences to determine which recorded television programs should be automatically deleted as the hard drive becomes full. For example, MythTV is an open-source Linux based Personal Video Recorder (PVR)—a video recording system similar to a DVR that runs on a PC platform. MythTV provides for auto-erase of older recorded television (TV) shows because there is only a fixed amount of disk storage space (e.g., 500 Gigabytes) to store recorded video. Among the user-selectable options are to auto-erase TV shows based only on the age (i.e., how long they have been stored) or to auto-erase TV shows based on an assigned priority. There are a large set of options for assigning a priority to a recorded TV show. The priority can be based on the TV channel it was recorded from, the physical device it was recorded from, or whether or not it's a one-time event (e.g., a movie) or part of a TV show series. There is also an extensible rule set allowing the advanced user to set priority based on many other criteria.

The viewer of a digital media frame is typically more interested in certain images than others. However, current digital media frames require the user to manually identify these images for deletion through a tedious process. What is needed is a way to automatically determine a default importance value for all digital media assets on a digital media frame such that even without further user specification some actions may be performed on the digital media assets based on the importance value.

### SUMMARY OF THE INVENTION

The present invention represents a digital image display device for displaying a collection of digital media assets, comprising:

a display screen;

a processor;

a network connection for communicating with a network;

an image memory; and

a processor-accessible program memory storing executable instructions for causing the processor to execute the steps of:
receiving a plurality of digital media assets using one or more different origins;
determining an importance value for each of the received digital media assets responsive to an associated sharing breadth; and
performing an operation using at least one of the received digital media assets responsive to the determined importance value.

This invention has the advantage that actions performed by the digital media frame on digital media assets may be based on a determined default importance value without the user explicitly specifying the value. This provides for automatically controlling the behavior of the digital media frame responsive to the importance of particular digital media assets.

It has the additional advantage that the digital media assets received from particular origins including E-mail, social networking websites, digital media asset sharing websites, web browser downloads, direct network downloads, memory card downloads, or computer connected downloads may be determined to have inherent sharing breadths from the identity of the origin, or may make available explicit information with regard to the sharing breadth of a given digital media asset or its container, such that the default importance value for a digital media asset may be determined based on the sharing breadth.

### BRIEF DESCRIPTION OF THE DRAWINGS

FIG. 1 is a high-level diagram depicting the components of a digital image display device;

FIG. 2A and FIG. 2B depict the front and back of a digital image display device;

FIG. 3 is a high-level system diagram depicting how the digital image display device of FIG. 1 communicates with other devices to receive content and configuration information;

FIG. 4A is a high level flow diagram depicting a general image display process;

FIG. 4B is a high level flow diagram depicting a general system communications process;

FIG. 5 is a flow diagram showing a method for performing operations on stored digital media assets responsive to a sharing breadth in accordance with the present invention;

FIG. 6 is a graphical user interface which can be used to remotely configure a digital image display device;

FIG. 7A depicts a collection of digital media assets stored in the digital media frame;

FIG. 7B depicts digital media assets from the collection of digital media assets having a higher importance value responsive to the associated sharing breadth; and

FIG. 7C depicts digital media assets from the collection of digital media assets having a lower importance value responsive to the associated sharing breadth.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a non-transitory computer readable storage medium, which can include, for example; magnetic storage media such as a magnetic disk (e.g., a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital media frames and related circuitry for providing digital interfaces, digital image storage, digital image processing, and image display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of digital media frames will be familiar to one skilled in the art. It will be obvious that there are many variations of this embodiment that are possible and are selected to reduce the cost, add features or improve the performance of the digital media frame. The present invention is illustrated by way of example and not limitation in the accompanying figures.

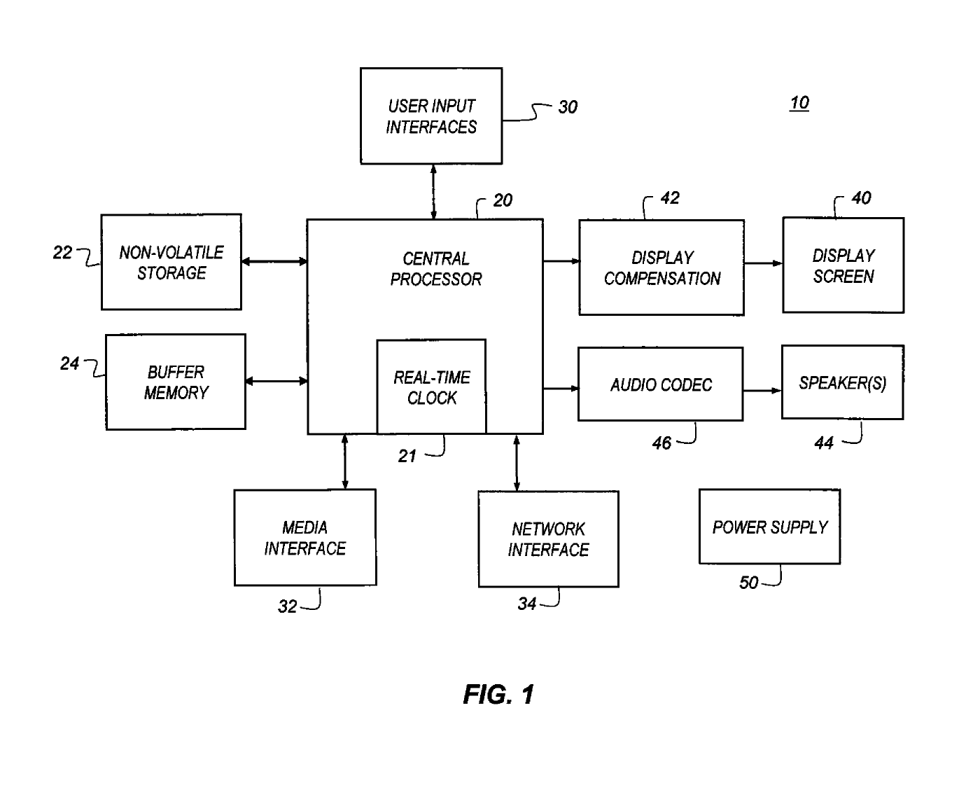

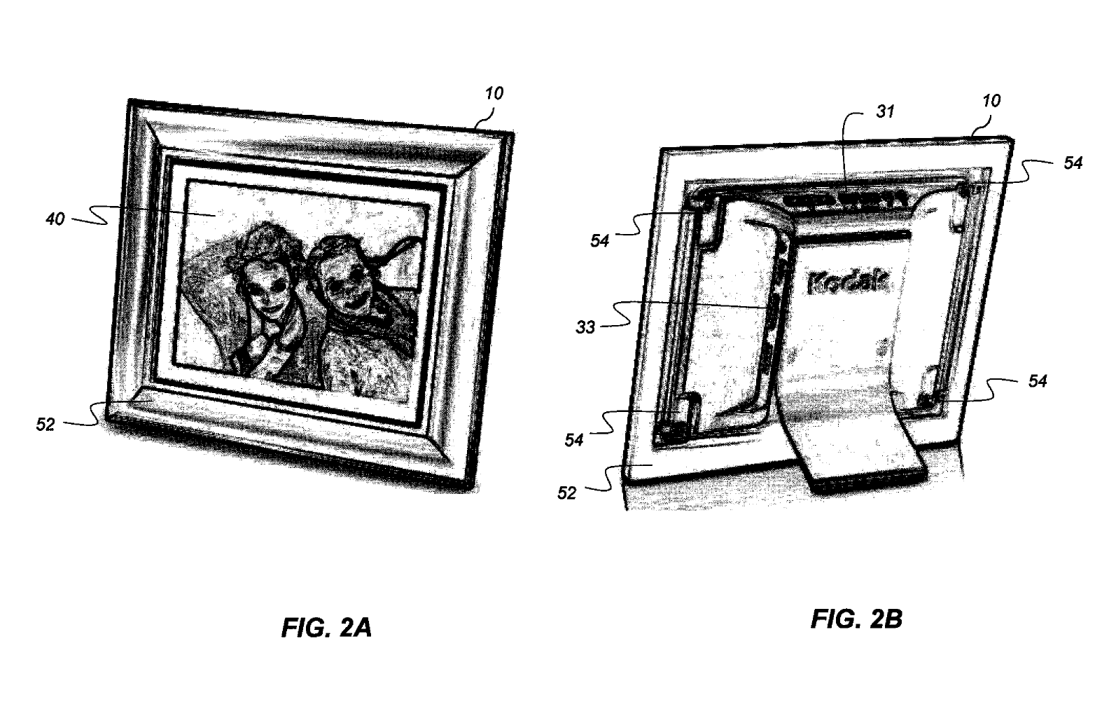

FIG. 1 is a high-level block diagram depicting an embodiment of a digital image display device 10. In a preferred embodiment, the digital image display device 10 is a digital media frame (i.e., a digital picture frame or a digital photo frame). However, in other embodiments, the digital image display device 10 can be any device having the ability to display digital media assets on a soft-copy display. Digital media assets would include both digital still images and digital video images. Examples of other types of digital image display devices 10 that can be used in accordance with the present invention would include tablet computers, personal computers, hand-held electronic devices (e.g., smart phones, PDAs or digital media players) and digital televisions. FIG. 2A depicts an embodiment of a front view of the digital image display device 10, and FIG. 2B depicts an embodiment of a rear view of the digital image display device 10. The digital image display device 10 includes a frame surround 52 which can be removed by moving the sliders 54 and replacing the frame surround 52 with a different frame surround, which may have a different color, finish, etc.

The digital image display device 10 allows a user to display digital media assets with minimal user intervention. The digital media assets to be displayed typically include digital still images captured with a digital camera. The digital media assets to be displayed can also include video clips, graphic images, text, and animations. The digital media assets can also include audio information, such as music, speech, and sound effects.

Referring to FIG. 1, a central processor 20 in the digital image display device 10 provides the overall control of the digital image display device 10. The central processor 20 is coupled to a user input interfaces block 30, which enables a user of the digital image display device 10 to select operating modes and images to be displayed. The central processor 20 is also coupled to a media interface block 32, and a network interface block 34, which are used to provide digital media assets to the digital image display device 10. The central processor 20 is also coupled to a non-volatile storage block 22 via an interface, which provides a processor-accessible program memory that stores executable instructions that are used to control the operation of the central processor 20. Non-volatile storage block 22 can also serve as a processor-accessible image memory for storing a collection of digital media assets.

The central processor 20 is also coupled to a buffer memory block 24, which temporarily stores digital media assets for display on display screen 40. The central processor 20 is also coupled to a display compensation block 42, which processes the digital media assets and provides the compensated digital media assets to the display screen 40. The central processor 20 is also coupled to an audio codec block 46, which processes digital audio information and converts the digital audio information to one or more analog signals, which are provided to one or more speakers 44.

The user input interfaces block 30 can be provided using various conventional user input devices and circuits. For example, the user input interfaces block 30 can include a group of user buttons 31, such as those provided on the upper back of the digital image display device 10 in FIG. 2B. These user buttons 31 can include, for example, a forward function button, a reverse function button, and a pause function button. The forward function button allows the user to initiate the display of the next image in a playlist, the reverse function button allows the user to initiate the display of the previous image in a playlist, and the pause function button allows the user to initiate the continued display of the current image, until a different function button is pressed by the user. The user buttons 31 can also include a “menu” button, a “select” button” and a number of cursor movement buttons, such as “up,” “down,” “left” and “right,” or some subset thereof. These can be used to select various operating modes.

In some embodiments, the user input interfaces block 30 includes a touch screen interface provided on the front surface of the display screen 40. In some embodiments, the touch screen interface can be implemented using IR emitters and detectors in front of, and parallel to, the display screen 40. A “touch” is detected by determining which IR beams have been blocked by the viewer's finger. In some embodiments, this can be implemented using a relatively small number of emitters and detectors. For example, using 5 emitters spaced vertically and 8 detectors spaced horizontally, enables the detection of 5×8 positions on the display screen. This is enough to allow touch buttons icons to be displayed on the display screen 40 and discern which button icon was touched by the viewer.

In some embodiments, the user input interfaces block 30 includes a touch sensitive input surface that can be positioned adjacent to the display screen 40. For example, the KODAK EASYSHARE P730 Digital Frame includes two “Quick Touch Border” capacitive touch strips, including a horizontally oriented touch strip adjacent the bottom of the display screen 40 and a vertically oriented touch strip adjacent the right side of the display screen 40. Menu items are displayed on the display screen 40 adjacent to these touch strips, and the viewer touches the strip at the appropriate location in order to select menu items. One advantage of the Quick Touch Border is that it keeps fingerprints off of the display screen 40.

In some embodiments, the user input interface can also include a pointing device such as a computer mouse, a joy stick, a track ball, or a track pad. In some embodiments, the user input interface can also include a remote control input device. The remote control can include user inputs which replicate some or all of the functions provided by the user buttons 31. In some embodiments, the user input interface can also include a voice recognition interface (including a microphone and speech recognition processor) or a gesture recognition interface that includes a sensing device (such as a camera) which recognizes user hand gestures or other user movements.

Non-volatile storage block 22 represents non-volatile storage memory, which may include, for example, flash EPROM memory. Non-volatile storage block 22 provides a processor-accessible program memory for storing executable instructions, such as firmware programs, for controlling the operation of the central processor 20.

In some embodiments, the firmware programs stored in non-volatile memory block 22 can be updated or replaced by new firmware provided using the media interface block 32 or the network interface block 34. In some embodiments, other types of non-volatile memory, such as Read Only Memory (ROM), magnetic disk storage or optical disc storage, can be used. In some embodiments, the central processor 20 includes an additional program memory (not shown), and the firmware programs stored in the non-volatile storage block 22 are copied into the program memory before being executed by the central processor 20.

The non-volatile storage block 22 can also be used to provide a processor-accessible image memory for storing a collection of digital media assets such as still images, video clips, sounds, music, graphics, text, and other types of content which can be used to create the images displayed on the display screen 40 and the sounds output from speaker(s) 44. These sounds can include sounds captured by the digital still or video camera when the digital media assets were captured. These sounds can also include sounds (such as audio annotations) captured when the images were previously viewed, either by the user or another individual. These sounds can also include songs or music soundtracks that have been associated with the digital media assets. In some embodiments, at least some of the stored digital media assets are associated with particular events either automatically as a result of the image capture date, or as a result of manual selection by the user. The sounds can also include audio content associated with the particular events.

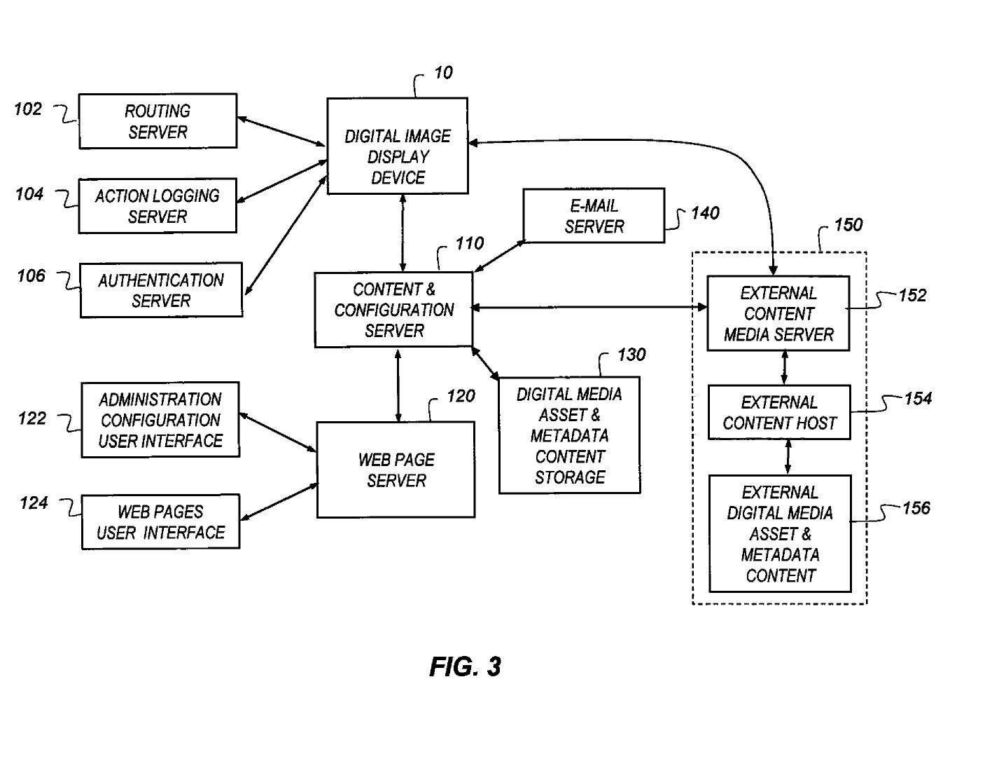

The non-volatile storage block 22 also stores auxiliary information (e.g. metadata) associated with the digital media assets. This metadata can include the date and time the image was captured by a digital capture device (e.g., a digital still camera or a digital video camera), or the date and time the image was received by the digital image display device 10. The metadata can also include data which identifies or characterizes the individual or service that provided the digital media assets that was transferred to the digital image display device 10 using the system to be described later in reference to FIG. 3.

Buffer memory block 24 is a relatively small memory (compared to non-volatile storage block 22) which provides fast memory access for displaying images. The buffer memory block 24 can use, for example, one or more dynamic random access memory (“DRAM”) or static random access memory (“SRAM”) integrated circuits.

The media interface block 32 receives digital media files from various local external devices, such as removable media devices. For example, the media interface block 32 can include memory card and USB interface connectors 33 (FIG. 2B), to enable the digital image display device 10 to display media files stored on various removable Flash memory cards, such as a Secure Digital (SD) card, a micro SD card, a Compact Flash (CF) card, a MultiMedia Card (MMC), an xD card or a Memory Stick, as well as USB memory “sticks” or “jump drives”. The digital media assets stored on these memory devices can be provided by digital computers, digital still cameras, digital video cameras, camera phones, PDAs, print and film scanners, and other types of digital imaging devices. The central processor 20 controls the media interface block 32 in order to transfer media files from the local external devices. The transferred files can be stored in the non-volatile storage block 22, or can be stored directly in the buffer memory block 24 for immediate display on the display screen 40. Thus, the media interface block 32, in combination with the removable memory card or memory “stick”, provides a processor-accessible image memory for storing a collection of digital media assets, such as digital images.

The network interface block 34 can be used to enable other devices, such as computers or mobile imaging devices, to transfer digital media asset files to the digital image display device 10. The network interface block 34 can be provided using a wired interface, such as an Ethernet cable interface or a wired telephone modem. The network interface block 34 can also be provided using a wireless interface, such as a WiFi (e.g. IEEE 802.11 WiFi standard) modem, a cellular modem, or a Bluetooth modem.

In some embodiments, the network interface block 34 provides a direct connection to the Internet, and is configured to read HTML (“HyperText Markup Language”) and to use TCP/IP (“Transmission Control Protocol/Internet Protocol”). In other embodiments, the network interface block 34 provides a connection to a local area network, which can then provide an Internet connection using a wired or wireless router or other type of network interface device, which either interfaces directly to the Internet, or to an Internet Service Provider (ISP).

The display compensation block 42 is used to adjust the image data for the characteristics of the display screen 40. This can include tone scale adjustments, color adjustments, sharpness adjustments or any other type of appropriate adjustment. It should be noted that in some embodiments, the display compensation block 42 can be implemented by the central processor 20. In other embodiments, the display compensation block 42 and central processor 20 can be integrated into the same integrated circuit (“IC”).

The display screen 40 displays images using a soft-copy display device, such as a color active matrix LCD (“Liquid Crystal Display”). Other types of soft-copy display devices may be used, such as an OLED (“Organic Light. Emitting Diode”) display, a CRT (“Cathode Ray Tube”), or various silicon-based displays.

A power supply 50 converts the AC power supplied via a wall plug to the proper DC voltages needed to provide power to all of the components of the digital image display device 10. In some embodiments, the power supply can include a re-chargeable battery, so that the digital image display device 10 can be portable, thus allowing it to be used for a period of time without a power cable, and outdoors. In some embodiments, the digital image display device 10 can include a solar panel which is used to charge the rechargeable battery.

In some embodiments, the digital image display device 10 includes a motion sensor (not shown). The motion sensor can provide a signal to the central processor 20, which controls the power supply 50 in order to supply power to the display screen 40 only when motion is detected. This reduces the power wasted when displaying images if there are no viewers in the vicinity of the digital image display device 10.

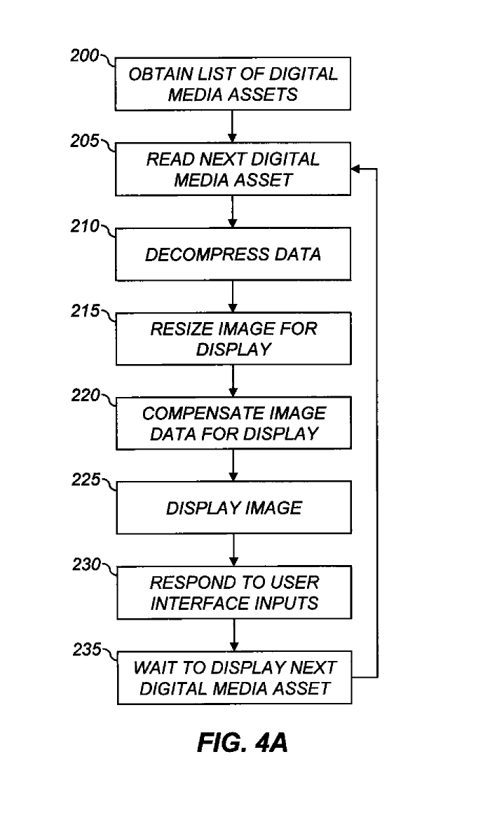

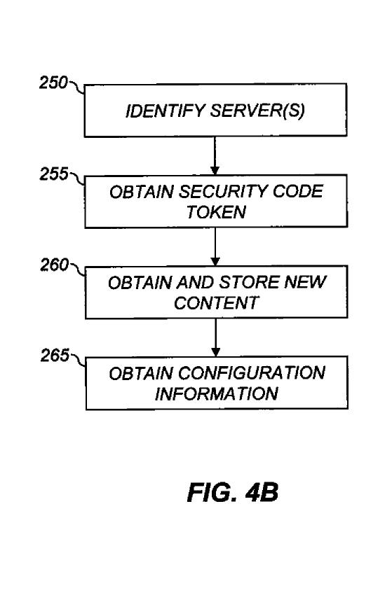

The central processor 20 runs two primary processes in order to display images and communicate with other system components, as will be described later in reference to FIG. 4A and FIG. 4B. A real-time clock 21 in the central processor 20 provides a date/time value. In some embodiments, the real-time clock 21 is manually configured by the user while in other embodiments, the real-time clock is configured using information accessed on an external device such as a Network Time Protocol (NTP) server using the network interface block 34.

It will be understood that the functions of the central processor 20 can be provided using a single programmable processor or by using multiple programmable processors, including one or more digital signal processor (DSP) devices. Alternatively, the central processor 20 can be provided by custom circuitry (e.g., by one or more custom integrated circuits (ICs) designed specifically for use in digital media frames), or by a combination of programmable processor(s) and custom circuits. It will be understood that connections between the central processor 20 and some of the blocks shown in FIG. 1 can be made using a common data bus. For example, in some embodiments the connection between the central processor 20, the non-volatile storage block 22, the buffer memory block 24, the media interface block 32, and the network interface block 34 can be made using a common data bus.

FIG. 3 is a high-level system diagram depicting an embodiment of how the digital image display device 10 can communicate over a network with other systems to receive content and configuration information. It will be understood that a large number of digital image display device 10 units, located at many different geographically dispersed locations, can be supported by the system depicted in FIG. 3. The digital image display device 10 communicates over a network (such as the Internet) with a routing server 102, an action logging server 104, and an authentication server 106. The digital image display device 10 also communicates over the network with content and configuration server 110. The content and configuration server 110 communicates with a web page server 120. The web page server 120 can be controlled by an administration configuration user interface 122 and a web pages user interface 124. The content and configuration server 110 can obtain digital media asset and metadata content and store it in digital media asset and metadata content storage 130. The digital media asset and metadata content can originate into this system from an E-mail server 140, from the web page server 120 or from one or more content providing systems 150. The content providing systems 150 can provide content from a variety of origins, such as Facebook, Flickr, the Kodak Gallery, and other on-line content storage systems and services.

Each content providing system 150 can include an external content media server 152 which communicates with an external content host 154 in order to supply external digital media asset and metadata content 156. The external digital media asset and metadata content 156 can be stored on hard drives or other digital storage devices or media that can be accessed by the external content host 154.

In some embodiments, the content and configuration server 110 only provides a list of digital media assets together with appropriate information about each digital media asset. The digital image display device 10 can subsequently access digital media asset files directly from the content providing systems 150.

It will be understood that the various blocks shown in FIG. 3 can be implemented using different hardware configurations. For example, the routing server 102, action logging server 104 and authentication server 106 can execute on the same physical hardware, or on different hardware. Furthermore, each server, such as routing server 102, may execute on multiple pieces of hardware in order to execute operations in parallel.

FIG. 4A is a high level flow diagram depicting a general image display process performed by the central processor 20 as a foreground process. In the obtain list of digital media assets step 200, the central processor 20 gets a list of digital media assets to be displayed from the non-volatile storage block 22 or from some other digital media asset storage location (e.g., storage media connected via the media interface block 32, or a remote storage location accessible via the network interface block 34). A digital media asset is a discrete piece of digital media content such as a digital still image, a digital video clip, a digital audio clip or music file, as well as graphics, text, and other types of content that can be used to create the images displayed on the display screen 40 and the sounds output from speaker(s) 44 of the digital image display device 10. A collection of digital media assets is the set of all the digital media assets that are available for display or playback on the digital image display device 10. A list of digital media assets is a list of the individual digital media assets in the collection of digital media assets. This list can be stored as a formatted text file (e.g. an XML file), as a database, or in some other custom storage format. The list can be provided in the display order in which content is to be displayed, or the display order can be specified as a separate field or as a subsequent list referring back to the assets in the list. In some operating modes of the digital image display device 10, the content is intentionally displayed in a randomized order.

In the read next digital media asset step 205, the central processor 20 reads the list and determines the next digital media asset to display from the list. The central processor 20 then reads the digital media asset from the non-volatile storage block 22 or the storage media connected to media interface block 32. In some embodiments, the central processor 20 can read the digital media asset from a remote storage site via the network interface block 34.

In the decompress data step 210, the central processor 20 decompresses the image data associated with the digital media asset and stores the decompressed image data in the buffer memory block 24. If the digital media asset is a video file, such as an MPEG 2 or MPEG 4 video file, the central processor 20 performs real-time decompression of the compressed video file.

In the resize image for display step 215, the central processor 20 scales the image for display, by resizing the image as necessary in order to match the image size (i.e., the display screen resolution) required by display screen 40. In some embodiments, the image size stored in buffer memory block 24 is slightly larger than the screen resolution, in order to allow for some panning/zooming effects as the image is displayed.

In the compensate image data for display step 220, the display compensation block 42 applies compensation to the image data before it is provided to the display screen 40. The compensation typically includes adjusting the image to account for the characteristics of the display screen 40 (e.g., an LCD panel). In some embodiments, the compensation may also adapt to the content of the specific image, for example, to provide image-specific enhancements.

In the display image step 225, the central processor 20 displays the current image on the display screen 40. The central processor 20 can also display visual messages or user interface controls on the display screen 40, to indicate to the user of the digital image display device 10 various operating modes and options that can be selected by the user. In some embodiments, the central processor 20 provides these messages and controls using an on-screen graphics buffer, which can be stored in a portion of buffer memory block 24. The graphics information provided from this on-screen graphics buffer can be blended with the currently displayed image when the user activates one of the user interface elements of the user input interfaces block 30, such as a touch screen interface. In some embodiments, the text and icons are transparently overlaid on top of the currently displayed image.

In the respond to user interface inputs step 230, if the user makes a selection using one of the user input elements, the central processor 20 takes one or more actions in response to the user selection. This can include, for example, changing the display time for images, deleting an image from the collection of digital media assets, or selecting a subset of the collection of digital media assets to display.

In the wait to display next digital media asset step 235, the central processor waits until the real-time clock 21 has advanced by a specified time interval between images, and then execution returns to the read next digital media asset step 205. The specified time interval can be a factory default time interval (e.g., 10 seconds per image) or can be a time interval selected by the user using appropriate user interface elements. The central processor 20 also controls the type of transition between images. The transition is a mechanism of “retiring” the current image while “phasing in” the next image. For example, one type of image transition moves the current and next images in one direction (e.g. left to right, or top to bottom) such that the current image moves out while the next image moves in. In another example, the image transition fades out the current image while fading in the next image on top of the current image. Those skilled in the art will recognize that many different types of transitions can also be used.

FIG. 4B is a high level flow diagram depicting a general system communications process for secure information exchange over an insecure network, which is performed by the central processor 20 via the network interface block 34 as a background process. In some embodiments, the network interface block 34 is a WiFi wireless interface, which enables the digital image display device 10 to wirelessly communicate with various servers such as routing server 102, action logging server 104, authentication server 106 and content and configuration server 110 over a network, such as the Internet.

At startup, an identify server(s) step 250 is performed, during which the digital image display device 10 interfaces via network interface block 34 over the Internet to the routing server 102 at a known server location, in order to identify itself and determine how to proceed. The routing server 102 returns information to the digital image display device 10 that indicates which server(s) the digital image display device 10 should communicate with for all subsequent functions. The only address that is not allowed to change is the path to this routing server 102.

In the obtain security code token step 255, the digital image display device 10 uses a secure communication method (e.g. https://) to query the authentication server 106 for a security code to communicate with the rest of the system. This query involves transmission of private information that is known by both the digital image display device 10 and the authentication server 106. The authentication server 106 generates a temporary security token and returns the token to the digital image display device 10. The token is made available to other parts of the server (and other servers) to allow authentication of the particular digital image display device 10 for future operations.

When the time window for the authentication token expires, any operations from the digital image display device 10 to one of the servers (other than the authentication server 106) will be rejected. In this situation, the digital image display device 10 then communicates with the authentication server 106 in order to acquire a new authentication token, before continuing with other operations. The use of a temporary token for most of the communications between the digital image display device 10 and each of the servers has the advantage of minimizing exposure to the private information shared between the digital image display device 10 and the authentication server 106 and the advantage of minimizing the computation required for subsequent communications by reducing the need for secure communications with a temporary token.

In the obtain and store new content step 260, the digital image display device 10 communicates with the content and configuration server 110 in order to retrieve any new content that may be available. The digital media asset and metadata content provided by the content and configuration server 110 is organized into groups of pictures that are grouped by some combination of: the origin of the content (e.g., E-mail, Facebook, Flickr, or Kodak Gallery), a unique identifier of the sender of that content (e.g., the E-mail address of the sender who provided the content), the sharing breadth of that content (e.g., how many other people the content was shared with), and the date and time that the particular content was shared (or the instance of sharing). In some embodiments, a direct network upload can be used to provide content directly to the digital image display device 10. The direct upload can make use of various interfaces such as the well-known FTP or REST interfaces.

The digital media asset and metadata content provided by the content and configuration server 110 may also be organized by other information related to each particular content such as the location where the particular content was captured, keywords associated with the particular content, names or identity of people captured in the particular content, or things captured in the particular content.

The digital media asset and metadata content is obtained through a separate interface to content and configuration server 110, and is stored using an appropriate non-volatile storage (not shown) available to the content and configuration server 110. The content and configuration server 110 sends a description of the new content to be stored on the digital image display device 10. The central processor 20 in the digital image display device 10 then individually retrieves each of the digital media assets defined by the content and configuration server 110 and stores each digital media asset in the non-volatile storage block 22 in the digital image display device 10. The digital image display device 10 also transfers metadata related to each digital media asset, such as the origin (e.g., E-mail, Facebook, Flickr or Kodak Gallery) or sharing breadth, an identifier for the individual providing the digital media asset, an identifier of the sharing instance, and any descriptive text available related to the digital media asset. In some embodiments, the digital media assets are only downloaded from the content and configuration server 110 at the time when they are to be displayed on the digital image display device 10, and are not stored locally in the non-volatile storage block 22 in the digital image display device 10. In some embodiments, the digital media assets are stored in non-volatile storage block 22 using a cache mechanism and the digital media assets are retrieved from the non-volatile storage block 22 if the digital media asset is stored in the non-volatile storage block 22 and has not been updated on the content and configuration server 110, and further, if the digital media asset is not stored in the non-volatile storage block 22 the central processor 20 retrieves the digital media asset from the content and configuration server 110 and stores the asset into the cache mechanism stored on the non-volatile storage block 22. The details of the data cache mechanism will be familiar to one knowledgeable in the arts.

The user can add content to the digital image display device 10 by using a web browser upload via the web pages user interface block 124 to upload digital media assets and other digital media assets to the web page server 120. The web page server 120 then stores these digital media assets and appropriate metadata.

In obtain configuration information step 265, the digital image display device 10 communicates with the content and configuration server 110 in order to retrieve configuration information. The configuration information includes settings such as the type of slideshow transition, the time interval for displaying each slideshow image, and the time of day to automatically turn the digital image display device 10 on and off.

In some embodiments, factory default configuration information is stored on the content and configuration server 110 automatically when a digital image display device 10 is registered. The user can utilize the web pages user interface block 124 to modify the configuration information. Additionally, configuration information can be modified by a system administrator using the administration configuration user interface 122, in order to address any service related issues or to provide updates.

The user can use the web pages user interface block 124 to permit E-mail transfer of digital media assets to their particular digital image display device 10. In this case, the user enters a specific E-mail address to enable content to be sent to their digital image display device 10. When E-mail is sent (typically by others) to that address on the E-mail server 140, the digital media assets and other relevant content are extracted from the E-mail and transferred to the digital media asset and metadata content storage 130. Metadata about the sender, sharing date, etc. is also stored in association with this content.

The user can also use the web pages user interface block 124 to configure their digital image display device 10 to receive digital media assets that are provided from one or more content providing systems 150 through various external services on the Internet. There are two primary mechanisms for how content is transferred from the external content providing systems 150, depending on how the external system operates.

In a first “pull” mechanism, the content and configuration server 110 periodically polls the external content media server 152 to determine whether new external digital media asset and metadata content 156 is available from external content host 154. If new content is available, the content and configuration server 110 retrieves the metadata for the new content and stores it in the digital media asset and metadata content storage 130. The original digital media asset data (e.g., still digital image or digital video file) is not transferred. When the digital image display device 10 later retrieves the list of digital media assets to retrieve, the URL for this new digital media asset will point back to the corresponding external content media server 152.

In a second “push” mechanism, the external content media server 152 provides a notification when new external digital media asset and metadata content 156 is available from external content host 154. In this case, the content and configuration server 110 configures the external content media server 152 to provide a notification whenever relevant additions or changes are made for the content requested. The external content media server 152 then notifies the content and configuration server 110 when content is added, modified or removed. The content and configuration server 110 then updates the digital media asset and metadata content stored on the digital media asset and metadata content storage 130 to reflect the new state of the external content providing systems 150. It will be understood that the content and configuration server 110 stores configuration information for a large number of digital image display device 10 units, and that each digital image display device 10 can be configured to permit content to be provided from a number of different external content providing systems 150 (such as Facebook, Flickr, Kodak Gallery, etc.) using “pull” or “push” mechanisms. The obtain and store new content step 260 and the obtain configuration information step 265 are repeated at regular intervals (e.g., every ten minutes) in order to obtain new content for digital image display device 10. In another embodiment, the obtain configuration information step 265 can be initiated by a message being “pushed” from the content and configuration server 110 to the digital image display device 10 that indicated new or updated content may be available on the content and configuration server 110.

In some embodiments, the digital image display device 10 has an “informational” mode as well as a “pictorial digital media asset” mode. The informational mode of digital image display device 10 displays various information, such as news headlines, financial data, advertising, and the like. The information can be displayed instead of, or along with, the pictorial digital media assets. In the latter case, the digital image display device 10 dedicates a portion of the display screen 40 to pictorial display while another portion of the screen is apportioned to informational display. The informational display can be located adjacent to the pictorial display, or can be overlaid on top of the pictorial display. The information to be displayed can be provided using the system depicted in FIG. 3. The types of information to be provided can be configured for a particular user of digital image display device 10 by using the web pages user interface block 124 to select the particular information of interest to the user. This can include information about particular stocks, sport teams, weather reports, news categories, shopping, gambling, etc., which are of interest to the user. In some embodiments, the information can be provided by various information content web servers (not shown) which provide content to the content and configuration server 110. In other embodiments, the digital image display device 10 can communicate directly with the external web sites (not shown) that provide the information, in order to receive and display web pages, using a web browser implemented in the digital image display device 10.

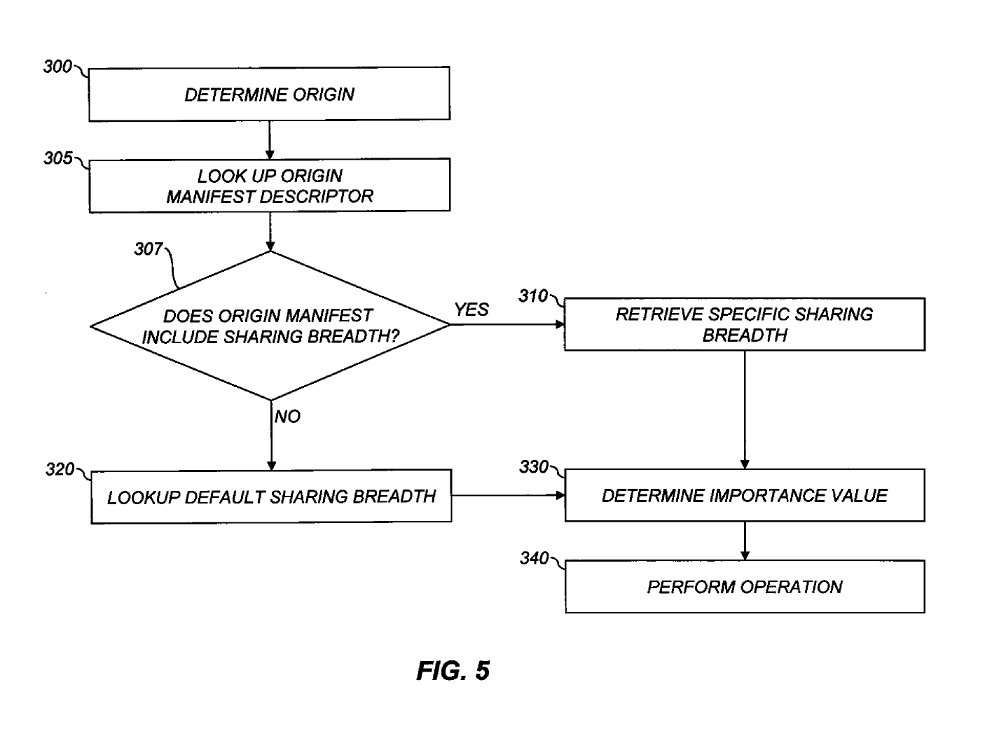

FIG. 5 is a flow diagram showing one embodiment for operating on digital media assets stored in the digital image display device 10 responsive to a sharing breadth. The sharing breadth is an absolute or relative indication of how broadly a given digital media asset has been shared among various people by the individual who shared the digital media asset.

In one embodiment, the sharing breadth may be assigned absolute values based on the number of different individuals with which the digital media asset was shared. For example, the origin of a particular digital media asset is from a social networking website (e.g., Facebook), and it is determined that the digital media asset was made available to the sharing individual's “friends.” In addition, the specific number of Facebook Friends with whom this digital media asset was shared is determined from the external content media server 152 for Facebook. In this embodiment, the number of friends can be used as the sharing breadth. In another example, the origin of the digital media asset is E-mail, and it is determined in conjunction with the E-mail server 140 that the digital media asset was sent to a distribution list including three people. In this embodiment, the number of recipients of the E-mail can be used as the sharing breadth.

In another embodiment, the sharing breadth may be assigned relative values based on the different origins of the digital media assets. For example, direct uploads of digital media assets from storage media attached to media interface block 32 may be assumed to be unshared. Digital media assets obtained from E-mail server 140 may be assumed to have a small sharing breadth as E-mails are typically only sent to a few people. Digital media assets obtained from the Facebook external content media server 152 may be assumed to have a medium sharing breadth as Facebook photos and videos are typically available to a user's friends. Digital media assets obtained from the Flickr external content media server 152 may be assumed to have a large sharing breadth as Flickr photos and videos are typically available to the public.

These examples of sharing breadths do not constitute all the ways in which sharing breadths may be determined. Sharing breadth is defined broadly to encompass any direct or indirect, or absolute or relative indication of the scope of sharing associated with a digital media asset. The sharing breadth may be explicitly specified by the individual doing the sharing, or it may be implicitly associated with the sharing method.

In determine origin step 300, the digital image display device 10 determines the origin (e.g., Facebook, Flickr, E-mail) of a digital media asset. In one embodiment, the digital image display device 10 examines metadata associated with the digital media asset to identify the origin of the digital media asset.

In look up origin manifest descriptor step 305, the digital image display device 10 queries information stored either in non-volatile storage block 22 or accessible over the network interface block 34 to determine if the origin's external content media server 152 or the e-mail server 140 is capable of providing data indicative of the sharing breadth of the digital media asset.

In sharing breadth available test 307, the digital image display device 10 makes a decision based on whether or not the sharing breadth is available from the origin. The data for this decision was acquired in look up origin manifest descriptor step 305 above.

There are two possible paths forward. If the sharing breadth is available, a retrieve specific sharing breadth step 310 is used to obtain the sharing breadth from the origin via the external content media server 152 or the e-mail server 140. If the sharing breadth is not available, a lookup default sharing breadth step 320 is used to determine a default sharing breadth associated with the origin of the digital media asset by accessing information stored either in non-volatile storage block 22 or available over the network interface block 34. The default sharing breadth can be a numerical value representative of a typical sharing breadth for digital media assets from the origin. For example, a default sharing breadth of “5” can be assigned when the origin is E-mail, a default sharing breadth of “20” can be assigned when the origin is a social networking website, and a default sharing breadth of “1000” can be assigned when the origin is a public image sharing website.

In determine importance value step 330, the digital image display device 10 determines an importance value for the digital media asset responsive to the sharing breadth value. Generally, the importance value will be higher for digital media assets having a narrower sharing breadth, and will be lower for digital media assets having a wider sharing breadth. For example, the importance value can be inversely related to the sharing breadth according to the following equation:

P=100/B

where P is the importance value and B is the sharing breadth.

Optionally, the determine importance value step 330 can also make use of other information about the digital media asset (e.g., digital media asset metadata) in the process of determining the importance value. In some embodiments, the sharing breadth or the importance value may be persistently stored as part of the digital media asset metadata in digital media asset and metadata content storage 130. In other embodiments, the sharing breadth or the importance value may be dynamically computed as needed by the digital image display device 10.

The user can use the web pages user interface block 124 (FIG. 3) to provide an E-mail address for their digital image display device 10. This E-mail address can then be provided to friends and family members. The friends and family members can send E-mails to this E-Mail address, and the E-mails will be received by E-mail server 140. The E-mails can include digital media assets, such as digital still images and digital video images. Digital media assets received in E-mails can be designated as having been received using an E-mail sharing method. E-mails sent by different individuals to the E-Mail address for the digital image display device 10 are designated as being provided by different sources. In some embodiments, the particular source can be identified by the E-mail address (e.g., a “sent by” or a “reply to” address) that was used to send the E-mail. The content and configuration server 110 can then use the “sent by” or “reply to” address in order to automatically identify the individual who provided the asset. In some embodiments, an indication of the sharing breadth can be determined from the number of different E-mail addresses listed in the “to” field of the E-mail message. For example, an E-mail that was sent to only the digital image display device can be assigned a sharing breadth of “1,” while an E-mail that was sent to 5 different users can be assigned a sharing breadth of “5.” The identity of the individual who provided the asset and the determined sharing breadth can be stored as metadata along with the asset in digital media asset and metadata content storage 130. It will be understood that each E-mail can provide a single image, or a plurality of images. The content and configuration server 110 can also store metadata which identifies the E-mail message that provided the digital media assets, so that a plurality of images provided by the same E-mail message can be associated together as a single “sharing instance.”

The user can also use the web pages user interface block 124 (FIG. 3) to enable their digital image display device 10 to receive digital media assets that are provided from one or more content providing systems 150, using various external services on the Internet. For example, the user can select the Kodak Gallery website, or a website associated with other on-line content storage systems and services. In addition to selecting the content providing system, the user can use web pages user interface block 124 to select the account name(s) used to store the assets that are to be provided to the digital image display device 10. In some embodiments, the user can use the web pages user interface block 124 to select digital media assets matching additional search criteria in order to select only a subset of the digital media assets associated with a particular account name. Examples of search criteria that can be used in accordance with the present invention would include search criteria to identify digital media assets included in a specified album, digital media assets associated with a specified keyword, digital media assets that include one or more specified persons or objects, digital media assets that were captured at a specified capture location, digital media assets that were captured within a specified date range, digital media assets that were received within a specified date range, or digital media assets were received with a specified sharing breadth.

The content providing systems 150 selected by user can include, for example, social networking websites such as Facebook and MySpace, or digital media asset sharing websites such as Kodak Gallery or Snapfish. In some embodiments, the user can use web pages user interface block 124 to select particular “friends”. The assets that these “friends” upload to their account on the social network website can then be automatically provided to the digital image display device 10 under the control of content and configuration server 110. It will be understood that each “friend” on the social network website serves as a different source of digital media assets. In some cases, the content providing system can provide an indication of how many people have access to view the digital media assets. This information can be used to provide an indication of the sharing breadth for the received digital media assets. In some embodiments, different sharing breadths can be assigned depending on how the digital media assets were selected for sharing. For example, if the user of the digital image display device 10 specifies a detailed search criteria to identify digital media assets of interest, such images can be treated as being received with a narrow sharing breadth since they satisfied a search criteria that was specific to a single individual. On the other hand, if the user of the digital image display device 10 simply identifies a number of Facebook friends and by default receives all new digital media assets that they post on their Facebook accounts, then such digital media assets can be treated as being received with a broad sharing breadth since the same set of images would be shared with all of the friends of the Facebook user.

In some embodiments, the importance value can be determined responsive to additional pieces of information in addition to the sharing breadth. In some embodiments, information determined from various pieces of metadata can be used to determine the importance value. For example, a higher level of importance can be assigned to more recently received digital media assets, digital media assets having a higher “star rating” (a user-supplied importance rating), digital media assets that are tagged with an indication that it includes a family member, or digital media assets determined to have a high aesthetic appeal.

In some embodiments, the determination of the importance value is also responsive to the source that provided the digital media asset. For example, digital media assets received from a family member can be given a higher importance value relative to digital media assets received from a friend.

Methods for combining various pieces of information to determine a single importance value are well known in the art. For example, importance factors can be determined corresponding to each piece of information and the importance value can be determined by multiplying the importance factors together.

The determined importance value can be used for many different purposes. In a preferred embodiment, the importance value is used to control an operation performed by the digital image display device 10 according to a perform operation step 340. In some embodiments, the importance value is used to control a deletion operation for deleting digital media assets from the non-volatile storage block 22 of the digital image display device 10 when the memory becomes full in order to make room for newly received digital media assets. In this case, digital media assets having a lower importance value are deleted before digital media assets having a higher importance value.

In some embodiments, the importance value is used to control an image display operation. For example, the image display operation can be controlled by adjusting an image display sequence, image display durations, image display effects, image transition effects, or customized content for the displayed digital media assets. In some embodiments, the image display operation adjusts the image display sequence such that digital media assets having higher importance values are displayed more often than digital media assets having lower importance values. Similarly, the image display operation can adjust the image display durations such that digital media assets having higher importance values are displayed using longer image display durations than digital media assets having lower importance values. In some embodiments, additional customized content (e.g., text messages or graphics) is displayed with, or overlaid on, digital media assets having a high importance level in order to draw additional attention to those digital media assets.

In some embodiments, the importance value is used to control an asset organization operation that controls the inclusion of digital media assets in an album or a playlist. For example, a album or a playlist can be formed that includes only digital media assets having an importance value that exceeds a predetermined threshold.

In some embodiments, the user interface of the digital image display device 10 provides a means for a user to search the digital media assets stored in the non-volatile storage block 22 (or on an accessible network server) according to a user-specified search criteria in order to select a subset of the digital media assets. In some embodiments, the specified search criteria can include an importance value search criterion that allows users to specify that they would like to find digital media assets exceeding a specified threshold importance value, or falling within a specified range of importance values. Once the subset of digital media assets is selected according to the search criteria, various operations can be performed on the selected subset. For example, the selected subset can be displayed, deleted, or used to form an album or a playlist.

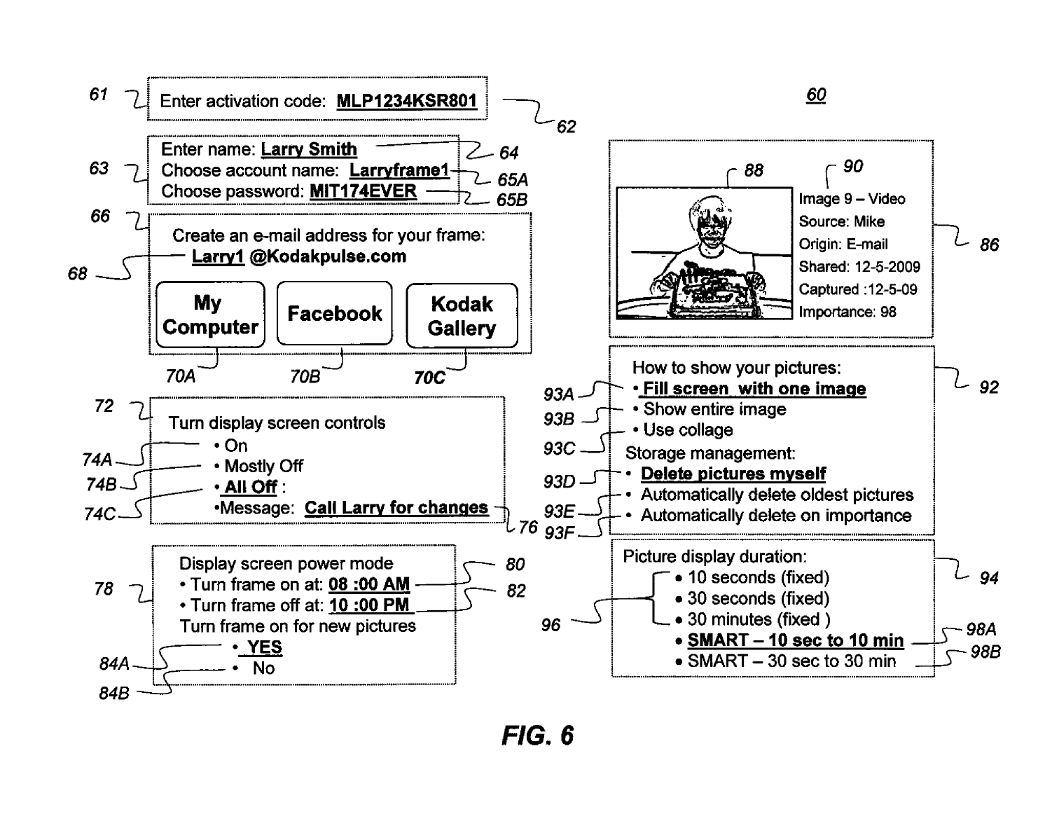

FIG. 6 shows a remote graphical user interface 60 that can be used by the user of the digital image display device 10, or by some other content supplier authorized to configure the digital image display device 10, to specify digital media asset content to be transferred over the Internet to the digital image display device 10. In a preferred embodiment, the graphical user interface 60 is provided by a web site accessed using a conventional web browser (e.g., Internet Explorer). The graphical user interface 60 includes unique identifier entry section 61, which prompts the content supplier to enter a unique identifier for the digital image display device 10 (FIG. 1), for example an activation code 62, shown as “MLP1234KSR801”.

In some embodiments, the unique identifier can be supplied as part of an E-mail or other electronic message received from the retailer which provided the digital image display device 10, so that it does not have to be manually entered by the purchaser or other content supplier. For example, an on-line retailer may send the purchaser an E-mail which includes a link associated with a particular activation code. When the purchaser “clicks” on the link in this E-mail, their computer can be directed to a web page having a version of the graphical user interface 60 that does not require unique identifier entry section 61. The E-mail link enables the content selections made by the content provider to be automatically associated with the particular digital image display device 10, without the content supplier either entering, or even seeing, the unique identifier that has been provided to them.

The graphical user interface 60 also includes an account creation section 63, which enables the content supplier to create an account for the particular digital image display device 10 associated with the activation code 62 on the content and configuration server 110, as described in commonly-assigned, co-pending U.S. patent application Ser. No. 12/948,892 to Landry, entitled “Method for remotely configuring a digital image display device,” which is incorporated herein by reference. The account creation section 63 prompts the content supplier to enter a name 64 (e.g., Larry Smith), and to specify an account name 65A (e.g., “Larryframel”) and an account password, 65B (e.g., “MIT174EVER”). The content supplier can update the selections made using graphical user interface 60 at a later date, by logging in using the account name 65A and account password 65B rather than requiring the content supplier to reenter the activation code 62. It will be understood that the content and configuration server 110 stores digital media asset and metadata content for a large number of different accounts, each associated with a particular digital image display device 10, using digital media asset and metadata content storage 130.

The graphical user interface 60 also includes content selection entry section 66, which enables the content supplier to define a frame E-mail address 68, by specifying an account identifier (e.g., “Larry1”) that will be appended to a predetermined E-mail address portion (e.g., “@Kodakpulse.com”) to create the frame E-mail address 68. The resulting E-mail address (e.g., Larryl@Kodakpulse.com”) enables digital media asset content to be transferred over the Internet to the digital image display device 10 associated with the activation code 62 entered in unique identifier entry section 61.

The content selection entry section 66 also includes icons 70A, 70B and 70C that can be used to select digital media asset content (e.g., digital still images or digital videos) from various content origins. These content origins can include the content supplier's computer, which is selected using icon 70A, a social networking website (e.g., Facebook), which is selected using icon 70B, and an image sharing website (e.g., Kodak Gallery), which is selected using icon 70C.

When the content supplier selects My Computer icon 70A, a new user interface screen (not shown) is activated to enable the content supplier to select digital media asset content stored on their computer to be supplied to the digital image display device 10. This can be done, for example, by selecting specific digital media assets, or collections of digital media assets (e.g., a folder of images), that are stored on a hard drive or some other memory accessible on their computer. Such digital media assets can be designated to have a narrow sharing breadth (e.g., “1”) since they were specifically designated by the content provider for loading onto the specific digital image display device 10.

When the content supplier selects the Facebook icon 70B, a new user interface screen (not shown) is activated to enable the content supplier to select a particular Facebook account (or a plurality of Facebook accounts) that will be used to supply images to the digital image display device 10. This can be done, for example, by selecting Facebook accounts corresponding to specific “friends.” When the friend's Facebook pages are updated, the new images can be automatically supplied to the digital image display device 10. Alternately, specific digital media assets or “albums” associated with a particular Facebook account can be selected in order to display only a portion of the digital media assets associated with a particular Facebook account.

When the content supplier selects Kodak Gallery icon 70C, a new user interface screen (not shown) is activated to enable the content supplier to select one or more Kodak Gallery accounts that will be used to supply images to the digital image display device 10. When new digital media assets are added to these accounts, the new digital media assets can be automatically supplied to the digital image display device 10. Alternately, specific “albums” associated with the specified Kodak Gallery accounts can be identified in order to display only a portion of the digital media assets associated with a particular Kodak Gallery account.

The remote graphical user interface 60 also includes a display screen controls section 72, which enables the content supplier to selectively disable some or all of the user interface controls of the digital image display device 10 that is associated with the activation code 62, as described in commonly-assigned, co-pending U.S. patent application Ser. No. 12/949,054 to Telek et al., entitled “Digital image display device with remotely disableable user interface,” which is incorporated herein by reference. The user interface controls in the display screen controls section 72 enable the content supplier to select between three options 74A, 74B and 74C. An On option 74A enables all of the user interface controls of the digital image display device 10 to operate normally. A Mostly Off option 74B disables all of the user interface controls of the digital image display device 10, except for a small subset of user interface controls. For example, the Mostly Off option 74B may enable only the “forward” and “reverse” function buttons described earlier in relation to FIG. 1. An All Off option 74C is selected by the content supplier in order to selectively disable all of the user interface controls of the digital image display device 10 which is associated with the activation code 62. (Even in the case where the All Off option 74C is selected, there may be certain controls such as the power button that are still operable.) The selected option, in this case All Off option 74C, is highlighted using a bold/underline font.

The display screen controls section 72 includes a message entry area 76, which enables the content supplier to input a message (e.g. “Call Larry for changes”) that will be displayed on the display of the digital image display device 10 when the user attempts to activate one of the user interface controls that has been disabled. This message allows the user, who may be an elderly grandparent, to understand that their digital image display device 10 is functioning properly, and guides them concerning who to contact if they desire to modify the operation of their digital image display device 10.

The graphical user interface 60 also includes a display screen power mode section 78. The display screen power mode section 78 enables the content provider to select an on time 80, which is the time when the power control circuit in the digital image display device 10 will activate an active display mode and begin displaying digital media assets each day. The display screen power mode section 78 also enables the content provider to select an off time 82, which is the time when the power control circuit in the digital image display device 10 will activate a reduced power mode and stop displaying digital media assets each day. In some embodiments, different on times and off times can be specified for weekdays and weekends to reflect the fact that users may have different viewing habits on those days due to work schedules.

The display screen power mode section 78 also enables the content provider to select either a Yes option 84A or a No option 84B, which determines whether the power control circuit in the digital image display device 10 will activate the active display mode and begin displaying new digital media assets when new digital media assets are received by the digital image display device 10, even if the power control circuit is in the reduced power mode when the new digital media assets are received, as described in the aforementioned commonly-assigned, co-pending U.S. patent application Ser. No. 12/949,054.

In some embodiments, if the Yes option 84A is selected, the display screen power mode section 78 can include user interface elements (not shown) to enable a user to specify an inactive time of day interval during which the power control circuit will continue to operate in the reduced power mode even if any new digital media assets are received from the content and configuration server 110. For example, the inactive time of day interval can be specified to correspond to the hours that the user is generally asleep so that the digital image display device 10 will not display images when there is no one there to observe the images, or when the light from the display screen 40 might disturb the user. In this case, if any digital media assets are received during the inactive time interval, then when the inactive time interval ends, the power control circuit can automatically be set to operate in the active display mode and the stored received digital media assets will be displayed on the display screen 40.

The graphical user interface 60 also includes a remote viewing interface section 86. The remote viewing interface section 86 can display a digital media asset 88, such as a digital still image or a digital video image, which corresponds to the digital media asset currently displayed on the display screen 40 of the digital image display device 10, as described in commonly-assigned, co-pending U.S. patent application Ser. No. 12/949,086 to Telek et al., entitled “Digital image display device with remote viewing interface,” which is incorporated herein by reference. This enables the content provider to know what digital media asset the viewer of the digital image display device 10 is currently viewing. This can be useful if the content provider is on the phone with the viewer and would like to comment on a particular digital media asset.

The remote viewing interface section 86 can also display metadata 90 associated with the displayed digital media asset. In the example, of FIG. 6, the metadata 90 includes a digital media asset identifier (e.g., “Image 9”), and a digital media asset type (e.g., “video”). The metadata 90 also includes a digital media asset source (e.g., “Mike”) providing an indication of the person who provided the asset, and a digital media asset origin (e.g., “E-mail”) providing an indication of the connection type by which the digital media asset was shared. For example, origins can include an E-mail origin (i.e., “E-mail”), social networking website origin (e.g., “Facebook”), digital media asset sharing website origin (e.g., “Kodak Gallery”), web browser upload origin (e.g., “Web Upload”) or direct network upload origin (e.g., “Network Upload”). The metadata 90 also includes a sharing date (“Shared”), which provides the date on which the digital media asset was transferred to the digital image display device 10, as well as a capture date (“Captured”), which is the date that the digital media asset was captured by a digital camera, or scanned by a digital image scanner. The capture date metadata can be provided, for example, by the date/time metadata included in the well-known Exif-JPEG image format when the digital media asset was captured by a digital camera.

The metadata 90 also includes an importance value (e.g. 98), where a higher value signifies a digital media asset with relatively more importance than a digital media asset with a lower value. According to some embodiments of the present invention, the importance value is determined responsive to a sharing breadth associated with the digital media asset. In some embodiments, the importance value is determined only from the sharing breadth. In alternative embodiments, the importance value is determined from both the sharing breadth and other metadata, for example an “importance” rating that is manually selected by a user (e.g. a “star” rating) or which is automatically determined from user behavior, as described in commonly assigned U.S. Pat. No. 7,620,270, “Method for creating and using affective information in a digital imaging system” to Matraszek et al., incorporated herein by reference. The importance value will typically have an inverse relationship to the sharing breadth. That is, the more widely a digital media asset is shared (e.g., a high sharing breadth value), the less importance it will be deemed to have, resulting in a relatively lower value for the importance value. For example, the origin of the digital media asset may be E-mail, and further determined in conjunction with the E-mail server 140 that the digital media asset was sent to two people. In this embodiment, the number of recipients of the e-mail would be used as the sharing breadth (indicating a relatively low value), and may also constitute the only factor in determining the importance value (a relatively high value) if no other metadata elements are considered.

It will be understood that many other types of metadata 90 can be displayed in association with the digital media asset 88. This metadata 90 can include, for example, the names of people pictured in the digital media asset 88, which can be provided either manually by users, or using a face recognition algorithm. Likewise, the metadata 90 can include the names of objects pictured in the digital media asset 88 or capture locations for the digital media asset 88. The metadata 90 can also include other types of metadata such as album names, playlist names, event names, captions, keywords and the like.

It will be understood that in some embodiments, the remote viewing interface section 86 can include controls (not shown) that enable the content provider to change which digital media asset 88 is currently displayed on the display screen 40 of the digital image display device 10. The controls may include, for example, forward and backward controls to display the next or previous digital media asset in a sequence, respectively. The controls may also include a display of many thumbnail images, and a selector (e.g., a cursor) that enables the content provider to select a particular digital media asset to display on the display screen 40 of the digital image display device.

In some embodiments, if the digital image display device 10 has not yet been unpacked from its package and connected to the network, the remote viewing interface section 86 can display a message indicating that the digital image display device 10 has not yet been connected to the network. This information can be used by the content provider to determine that the recipient of a gift of the digital image display device 10 may not have yet received it, or may not understand how to unpack it and connect it to a network. Similarly, if the digital image display device 10 has previously been connected to a network but is currently disconnected, the remote viewing interface section 86 can display a message indicating that the digital image display device 10 is currently inactive. In some embodiments, if the digital image display device 10 is in a reduced power mode, the remote viewing interface section 86 can display a message indicating that the digital image display device 10 is currently in the reduced power mode.

The remote graphical user interface 60 also includes a display mode and picture management section 92, which enables the content provider to select various preference settings. For example, the content provider can select between various display mode options provided by the digital image display device 10. In the example of FIG. 6, the content provider can select between several different image display styles including a “Fill screen with one image” option 93A (thus cropping off a portion of images having an aspect ratio that does not match the aspect ratio of display screen 40). Alternatively, the content provider can select a “Show entire image” option 93B, which displays the entire digital media asset on the display screen 40, using black or colored borders to “pad” the edges of the digital media asset. Alternatively, the content provider can select a “Use collage” option 93C to show a group of images together as a collage.

The display mode and picture management section 92 also enables the content provider to select between two picture management options, including a first “Delete pictures myself” option 93D where digital media assets stored in the non-volatile storage block 22 of the digital image display device 10 are manually deleted, a second “Automatically delete oldest pictures” option 93E where the oldest digital media assets (e.g., the digital media assets associated with metadata 90 having the oldest “shared” date) are automatically deleted from the non-volatile storage block 22 by the central processor 20, in order to free up sufficient memory so that newly received digital media assets can be stored in the non-volatile storage block 22, and a third “Automatically delete on importance” option 93F where the digital media assets with the lowest importance value (e.g., the digital media assets determined to have the highest sharing breadth) are automatically deleted from the non-volatile storage block 22 by the central processor 20, in order to free up sufficient memory so that newly received digital media assets can be stored in the non-volatile storage block 22. If the “Automatically delete on importance” option 93F is selected and multiple digital media assets are determined to have the same importance value, then, in some embodiments, the oldest of those digital media assets with equivalent importance values are deleted first according to the rules set forth for “Automatically delete oldest pictures” option 93E above. If the non-volatile storage block 22 becomes full when the “Delete pictures myself” option 93D is selected, then new digital media assets cannot be automatically downloaded to the digital image display device 10. In this case, a warning message can be displayed in the display mode and picture management section 92 indicating that the memory is full.

The graphical user interface 60 also includes a picture display duration section 94, which enables the content provider to select between various picture display durations, such as fixed display duration options 96 of 10 seconds, 30 seconds, or 30 minutes, or smart display duration options 98A and 98B. The smart display duration options 98A and 98B include a first smart display duration option 98A that uses display durations of 10 seconds to 10 minutes, and a second smart display duration option 98B that uses display durations of 30 seconds to 30 minutes. It will be understood that in some embodiments, smart display options can vary the duration of display within the range for each digital media asset based on the importance value determined for each digital media asset, as described in commonly-assigned, co-pending U.S. patent application Ser. No. 12/949,029 to Landry, entitled “Digital image display device with automatically adjusted image display durations,” which is incorporated herein by reference.

It will be understood that in some embodiments, the graphical user interface 60 can enable the content provider to choose between many other options related to how digital media assets are displayed on the display screen 40 of the digital image display device 10, providing many other types of preference settings. This can include choosing image transition methods (e.g., fades, wipes, pulls, etc.), image display sequence (e.g., random sequence, sorted by date) and image display effects (e.g., zoom and pan). It will be further understood that in some embodiments, the graphical user interface 60 can be used to select customized content to be displayed on the digital image display device 10 based on the date provided by the real-time clock 21, as described in commonly-assigned, co-pending U.S. patent application Ser. No. 12/911,959 to Krolczyk et al, entitled “Digital media frame providing customized content,” which is incorporated herein by reference. It will be further understood that in some embodiments, the graphical user interface 60 could be used to create icons for individuals who are, or are expected to be, the source of digital media assets provided to the digital image display device 10, as described in commonly assigned, co-pending U.S. patent application Ser. No. 12/946,055 to Landry et al., entitled “Image display device providing improved media selection,” which is incorporated herein by reference. It will be further understood that display options such as image transition methods, image display sequence, image display effects, or customized content may vary for each digital media asset based on the importance value determined for each digital media asset.

Returning to FIG. 3, the content and configuration server 110 transfers the digital media assets to the digital image display device 10. This can be done as described earlier in reference to obtain and store new content step 260 of FIG. 4B. In some embodiments, the digital image display device 10 can be in continuous communication with the content and configuration server 110. In other embodiments, the digital image display device 10 can instead connect and communicate with the content and configuration server 110 on an occasional basis, for example every ten minutes, or every hour, or when digital media assets are pushed down from the content and configuration server 110.

The digital image display device 10 receives digital media assets (e.g., digital still images and digital video images) and metadata from the content and configuration server 110 via the network interface block 34, and stores the digital media assets and metadata in the non-volatile storage block 22, or using a storage media attached to media interface block 32. The metadata can be stored using a variety of formats. For example, the metadata can be included in the image files, or can be stored separately from the image files (such as in a database file), or can be stored both in the image files and in a separate database. The metadata enables the stored digital media assets to be grouped according to the individual “source” that supplied the asset. The metadata also enables the stored digital media assets be grouped according to their origin (upload, E-mail, Facebook, Flickr, Kodak Gallery, etc.). The metadata also enables the stored assets to be grouped according to an “album”, a “playlist”, a “sharing breadth” or an “importance value.”

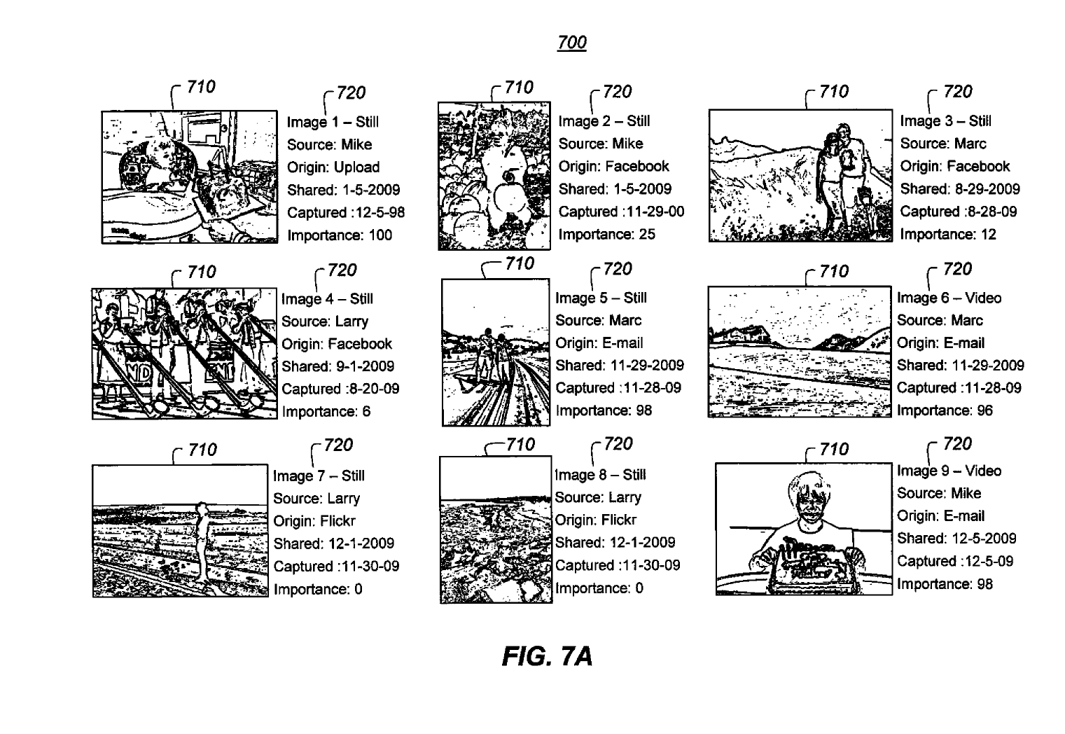

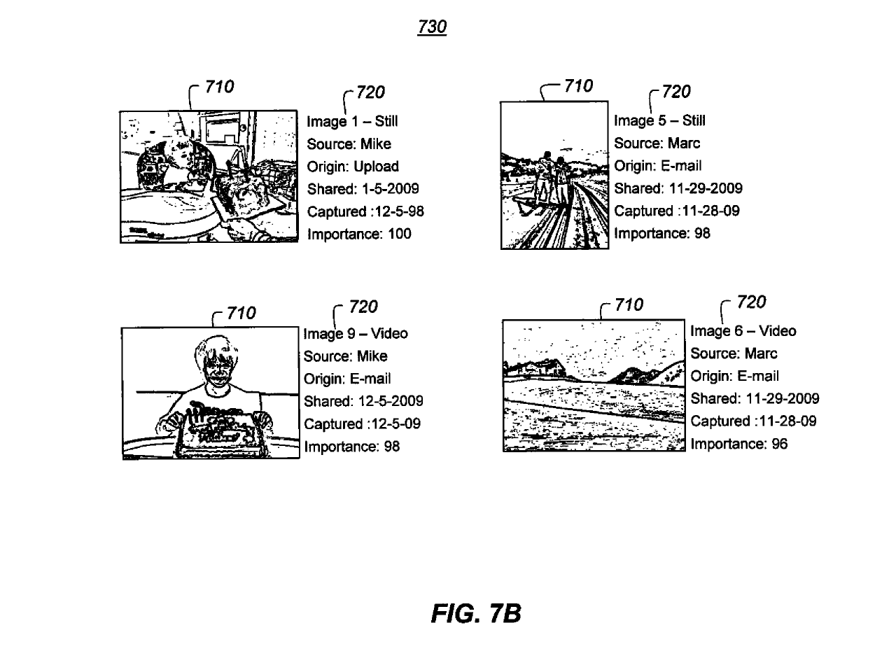

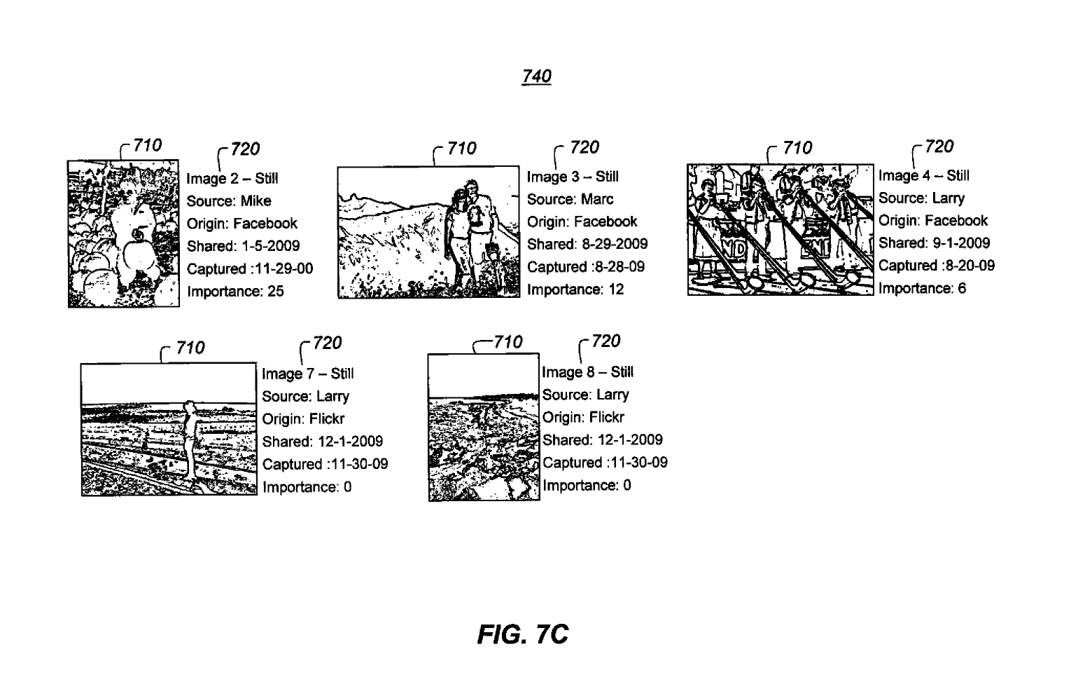

FIG. 7A depicts a collection of digital media assets 700 stored in the digital image display device 10 (FIG. 1), including nine particular digital media assets 710, and some of the associated metadata 720. The digital media assets 710 include two digital video clips (Images 6 and 9) and seven digital still images (Images 1-5 and 7-8). It will be understood that the digital image display device 10 typically stores a much larger number of digital media assets 710, for example several hundred or several thousand digital media assets 710.

Each of the digital media assets 710 depicted in FIG. 7A has associated metadata 720. The metadata 720 includes a digital media asset identifier (e.g., “Image 1”), and a digital media asset type (e.g., “still” or “video”). The metadata 720 also includes a digital media asset source (e.g., “Mike” or “Larry”) providing an indication of the person who supplied the digital media asset, and a digital media asset origin providing the origin from which the digital media asset was received. For example, origins can include an E-mail origin (i.e., “E-mail”), social networking website origins (e.g., “Facebook”), digital media asset sharing website origins (e.g., “Kodak Gallery”), web browser upload origins or direct network upload origins.

The metadata 720 also includes a sharing date (“Shared”), which provides the date on which the digital media asset was transferred to the digital image display device 10, as well as a capture date (“Captured”), which is the date that the digital media asset 710 was captured by a digital camera, or scanned by a digital image scanner. The capture date metadata can be provided, for example, by the date/time metadata included in the well-known Exif-JPEG image format when the digital media asset 710 was captured by a digital camera.

The metadata 720 also includes an importance value of the digital media asset (e.g., Image 2 has in importance value of 25). According to a preferred embodiment, the importance value is determined responsive to the sharing breadth. Optionally, the importance value can also be determined in conjunction with one or more other pieces of digital media asset metadata 720 (e.g., more recently received digital media assets can be given a higher importance value based on the sharing date than a digital media asset having the same sharing breadth but being received on an earlier date). For example, the origin of the digital media asset may be E-mail, and further determined in conjunction with the E-mail server 140 that the digital media asset was sent to two people. In this embodiment, the number of recipients of the E-mail (a relatively low value) can be used as the sharing breadth, and can also constitute the sole factor in determining the importance value (a relatively high value) if no other metadata elements are used to determine the importance value.

It will be understood that many other types of metadata 720 can be stored in association with the digital media assets 710 stored in the digital image display device 10. This metadata 720 can include, for example, the names of people pictured in the digital media assets 710, which can be provided either manually by users, or using a face recognition algorithm. Likewise, the metadata 720 can include the names of objects pictured in the digital media assets 710 or capture locations for the digital media assets 710. The metadata 720 can also include album names, playlist names, event names, captions, keywords and the like.

In FIG. 5, the determine importance value step 330 determines an importance value responsive to the sharing breadth value (optionally in conjunction with one or more other digital media asset metadata). The sharing breadth or the importance value or both may be persistently stored as part of the digital media asset metadata in digital media asset and metadata content storage 130. In alternative embodiments, the sharing breadth or the importance value or both may be dynamically computed as needed by the digital image display device 10.

FIG. 7B depicts a digital media assets subset 730 including digital media assets 710 from the collection of digital media assets 700 from FIG. 7A having a relatively high importance value responsive to the associated sharing breadth (which will be a low value due to its typically inverse relationship to the importance value).

FIG. 7C depicts a digital media assets subset 740 including digital media assets 710 from the collection of digital media assets 700 having a relatively low importance value responsive to the associated sharing breadth (which will be a high value due to its typically inverse relationship to the importance value).

It will be understood that the digital media assets and metadata can be provided to the digital image display device 10 using systems other that the one depicted in FIG. 3. For example, a personal computer connected to the Internet can be used to obtain digital media assets and metadata from a variety of individuals that are provided, for example, by E-mail server 140 or content providing systems 150. The digital media assets and metadata can then be stored on a removable storage device, such as a SD memory card or a USB jump drive. The removable storage device can then be removed from the personal computer and connected to the media interface block 32 of the digital image display device 10. The digital media assets and metadata can be transferred, under the control of central processor 20, from the removable storage device to the non-volatile storage block 22.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

A computer program product can include one or more storage media, for example; magnetic storage media such as magnetic disk, floppy disk, or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

### PARTS LIST

10 digital image display device
20 central processor
21 real-time clock
22 non-volatile storage block
24 buffer memory block
30 user input interfaces block
31 user buttons
32 media interface block
33 interface connector
34 network interface block
40 display screen
42 display compensation block
44 speaker(s)
46 audio codec block
50 power supply
52 frame surround
54 sliders
60 graphical user interface
61 unique identifier entry section
62 activation code
63 account creation section
64 name
65A account name
65B account password
66 content selection entry section
68 frame e-mail address
70A icon
70B icon
70C icon
72 display screen controls section
74A option
74B option
74C option
76 message entry area
78 display screen power mode section
80 on time
82 off time
84A option
84B option
86 remote viewing interface section
88 digital media asset
90 metadata
92 display mode and picture management section
93A option
93B option
93C option
93D option
93E option
93F option
94 picture display duration section
96 fixed display duration options
98A smart display duration option
98B smart display duration option
102 routing server
104 action logging server
106 authentication server
110 content and configuration server
120 web page server
122 administration configuration interface
124 web pages user interface
130 digital media asset and metadata content storage
140 E-mail server
150 content providing system
152 external content media server
154 external content host
156 external digital media asset and metadata content
200 obtain list of digital media assets step
205 read next digital media asset step
210 decompress data step
215 resize image for display step
220 compensate image data for display step
225 display image step
230 respond to user interface inputs step
235 wait to display next digital media asset step
250 identify server(s) step
255 obtain security code token step
260 obtain and store new content step
265 obtain configuration information step
300 determine origin step
305 look up origin manifest descriptor step
307 specific sharing breadth available test
310 retrieve specific sharing breadth step
320 lookup default sharing breadth step
330 determine importance value step
340 perform operation step
700 collection of digital media assets
710 digital media asset
720 metadata
730 digital media assets subset
740 digital media assets subset

1. A digital image display device for displaying a collection of digital media assets, comprising:
a display screen;
a processor;
a network connection for communicating with a network;
an image memory; and
a processor-accessible program memory storing executable instructions for causing the processor to execute the steps of:
receiving a plurality of digital media assets using one or more different origins;
determining an importance value for each of the received digital media assets responsive to an associated sharing breadth; and
performing an operation using at least one of the received digital media assets responsive to the determined importance value.

2. The method of claim 1 wherein the origin is E-mail, social networking websites, digital media asset sharing websites, web browser downloads, direct network, memory card, or computer connected downloads.

3. The method of claim 1 wherein the sharing breadth is determined to be a value responsive to the origin.

4. The method of claim 1 wherein sharing breadth is determined responsive to a value provided over the network interface.

5. The method of claim 1 wherein sharing breadth is stored as metadata.

6. The method of claim 1 wherein the determination of the importance value is also responsive to one or more pieces of metadata associated with the digital media asset.

7. The method of claim 6 wherein the pieces of metadata include a sharing date, a capture date, a user-supplied importance rating, an indication of the person who supplied the digital media asset, an indication of persons contained in the digital media asset, or an indication of the aesthetic appeal of the digital media asset.

8. The method of claim 1 wherein the determination of the importance value is also responsive to one or more values associated with the origin associated with the digital media asset.

9. The method of claim 1 wherein the determination of the importance value is also responsive to information pertaining to a source that provided the digital media asset.

10. The method of claim 1 wherein the operation performed is a deletion operation for deleting digital media assets from the image memory.

11. The method of claim 1 wherein the operation performed is a display operation for controlling the display of digital media assets on the display screen.

12. The method of claim 11 wherein the display operation is controlled by adjusting an image display sequence, image display durations, image display effects, image transition effects, or customized content displayed with the digital media assets.

13. The method of claim 1 wherein the operation performed is an asset organization operation that controls the inclusion of digital media assets in an album or playlist.

14. The digital image display device of claim 1 wherein the processor-accessible program memory further stores executable instructions for causing the processor to execute the steps of:
receiving input from the user of the digital image display device via the user interface identifying a search criterion;
selecting a subset of the digital media assets that satisfy the search criterion responsive to the determined importance values; and
performing an operation on the selected subset of digital media assets.

15. The digital image display device of claim 1 wherein the network connection is a wireless network connection.

16. The digital image display device of claim 1 wherein the user interface includes a touch screen, a pointing device, one or more buttons, a remote control, a gesture recognition interface or a voice recognition interface.

17. The digital image display device of claim 1 wherein at least some of the digital media assets are stored on a network server until such time that they are needed for display on the digital image display device.

18. The digital image display device of claim 1 wherein the received digital media assets are digital still images or digital video images captured using a digital camera, or are scans of photographic prints or film captured using a digital image scanner.

19. The digital image display device of claim 1 wherein the metadata includes metadata providing an image caption for the received digital media asset, metadata identifying one or more keywords associated with the received digital media asset, metadata identifying persons in the received digital media asset, metadata identifying objects in the received digital media asset, metadata identifying an event associated with received digital media asset, metadata identifying a capture location for the received digital media asset, metadata indicating an image capture date for the received digital media asset, metadata indicating a date that the received digital media asset was provided, metadata indicating a source of the digital media asset, metadata indicating an origin of the digital media asset, metadata indicating an importance value of the digital media asset, or metadata indicating a sharing breadth for received digital media asset was provided.
